(19) United States
(12) Patent Application Publication
(10) Pub. No.: US 2018/0300169 A1
(43) Pub. Date: Oct. 18, 2018

(54) METHOD FOR REDUCING THE RESPONSE TIME IN A TIME-CONTROLLED OPERATING SYSTEM

(71) Applicant: TTTech Computertechnik AG, Wien (AT)

(72) Inventors: Stefan Poledna, Klosterneuburg (AT); Hermann Kopetz, Baden (AT)

(21) Appl. No.: 15/951,700

(22) Filed: Apr. 12, 2018

(30) Foreign Application Priority Data
Apr. 13, 2017 (EP) 17166583.9

(51) Int. Cl. G06F 9/48; G06F 9/445; G06F 9/4401; G06F 9/50

(52) U.S. Cl. CPC G06F 9/48; G06F 9/5038; G06F 9/4405; G06F 9/44505

(57) ABSTRACT

The invention relates to a method for shortening the response time in a node computer (120) of a distributed time-controlled real-time computer system. An operating system task (205) of the node computer (120) computes the contents of control registers of the node computer (120), which characterize the properties of a runtime environment of the application task (207) in the node computer (120), prior to a start time (213), known a priori, of an application task (207) of the node computer (120), and writes these contents into the control registers of the node computer (120).

The invention relates to a method for shortening the response time in a node computer of a distributed time-controlled real-time computer system.

Moreover, the invention relates to a node computer of a distributed time-controlled real-time computer system, on which node computer an operating system is executed, and on which node computer application software is executed.

Furthermore, the invention relates to a distributed time-controlled real-time computer system having one or more node computers according to the invention.

The field of the invention is computer technology. The invention relates to a method for reducing the response time in a time-controlled computer system.

Developments in sensor technology and computer technology have allowed largely autonomous control of technical objects such as machines which operate autonomously, or vehicles which autonomously proceed toward a destination. There is a particular requirement for a rapid response by the computer system in these real-time computer applications.

In the following discussion, the totality of all programs that encompass the operating system in particular of a node computer is referred to as operating system software.

The totality of all programs encompassed by an application system, in particular on a node computer, is referred to herein as application software.

The term software, in particular of a node computer, is understood to mean the totality of the operating system software and the application software.

The execution of a program (i.e., a software process), in particular on a machine, for example on a node computer or in a communication network, is referred to herein as a task.

A task of the operating system software or of the operating system is also referred to as an operating system task, and a task of the application software or of the application system is also referred to as an application task.

The behavior of a task (regardless of whether it involves an operating system task or an application task) is modeled using a finite-state machine, and a task that computes a new result and a new state from provided input data and an old state is referred to as a computation task.

A communication task is a task that transmits a message or messages from a sender to a receiver. For example, this involves a task of a communication system that connects a sender and a receiver to one another.

According to the prior art, control systems (systems for the real-time control and/or regulation of a controlled object, for example the technical objects and vehicles mentioned above) periodically run on a distributed computer system, in particular a real-time computer system [1, p. 7]. Such a distributed computer system comprises a number of node computers that exchange data via a communication system.

The controlled object is observed at periodic observation times (sampling points). The detected data form the basis for the fastest possible computation of new setpoint values for actuators, which influence the behavior of the controlled object.

The periodically repeating execution of a sequence of computation tasks and communication tasks, which must be carried out after each observation, is referred to as a frame.

One or more real-time transactions (RT transactions, see [1, p. 24]) may run in a frame.

Two time parameters are associated with each frame:
the frame interval (sampling time) indicates the time interval between two successive frames. The number of frames processed per second is often expressed in Hertz (Hz).
the execution time (also referred to as the response time) indicates the time interval between a sampling point and the output of the results of a frame to actuators of the controlled object. The shorter the execution time of a frame, the better the quality of a control system. For very fast processes, a response time of less than 100 μsec may be necessary.

It is an object of the present invention to reduce the execution time of a frame in a time-controlled distributed computer system.

This object is achieved by a method and a node computer mentioned at the outset, in that according to the invention, an operating system task of the node computer computes the contents of control registers of the node computer, which characterize the properties of a runtime environment of the application task in the node computer, prior to a start time, known a priori, of an application task of the node computer, and writes these contents into the control registers of the node computer.

Advantageous embodiments of the method, node computer, and computer system according to the invention are described below:
an initialization task checks the contents of the control registers of the node computer, which characterize the properties of the runtime environment of the application task, prior to the start time, known a priori, of the application task;
a or the initialization task performs an initialization of the data structures of the application task prior to the start time, known a priori, of the application task.

The invention is described below with reference to one exemplary embodiment illustrated in the drawings, which show the following:

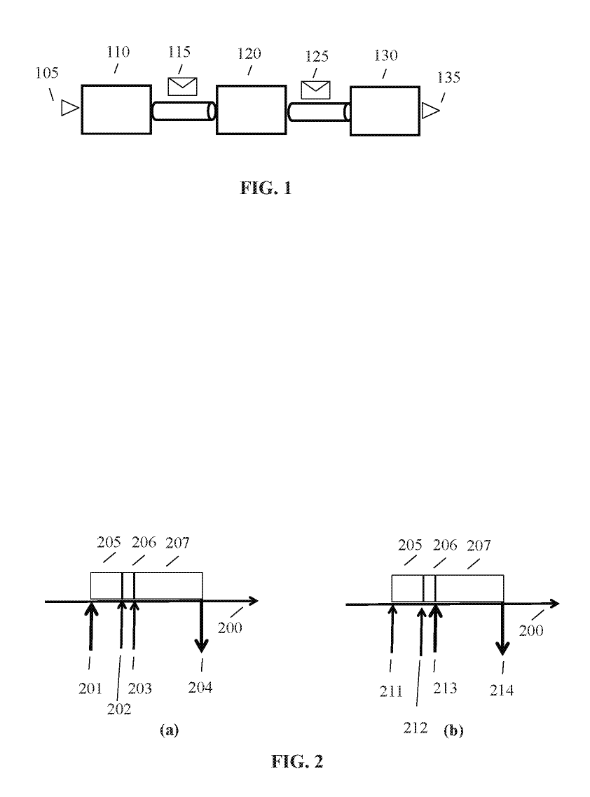

FIG. 1 shows a simple real-time transaction running within a frame,

FIG. 2a shows the sequences of operating system tasks and application tasks in an event-controlled node computer, using the example of the node computer 120 in FIG. 1, and

FIG. 2b shows the sequences of operating system tasks and application tasks in a time-controlled node computer, using the example of the node computer 120 in FIG. 1.

For the sake of simplicity, reference is made to “a sensor” and “an actuator” below, since the number of these elements is immaterial for an understanding of the invention. However, it is understood by those skilled in the art that two or more sensors and/or two or more actuators may also be provided, even if this is not explicitly mentioned.

According to the current prior art, in the majority of cases a real-time transaction corresponding to the principle of event control is processed. In these systems, a node computer 110, as shown in FIG. 1, detects raw data (see [1, p. 233]) with a sensor 105 at periodic, nonglobally synchronized observation times. After preprocessing of the sensor data by the node computer 110, a message 115 containing the calibrated sensor data (measured data, see [1, p. 233]) is sent to the node computer 120 via an event-controlled communication system. As soon as the message 115 arrives at the node computer 120 (in an event-controlled system, the point in time 201 (see FIG. 2a) at which the message 115 arrives at the node computer 120 is not known a priori), the node computer 120 begins a context switch, and accordingly computes new setpoint values by means of a specified algorithm, and sends these new setpoint values in the message 125 to an actuator controller 130 via an event-controlled communication system. The node computer (actuator controller) 130 transfers the setpoint values to an actuator 135.

Once again with reference to FIG. 1, a time-controlled computer system is considered below; i.e., it is now assumed that FIG. 1 represents a time-controlled, in particular a distributed time-controlled, computer system. In a time-controlled system, the points in time at which the controlled object is observed and messages are sent and received are synchronized with a global time. These points in time are set a priori. At a periodic observation time 211 known a priori (FIG. 2b), the node computer 110 detects raw data (see [1, p. 233]) with a sensor 105. After the sensor data are preprocessed by the node computer 110, a message 115 containing the calibrated sensor data (measured data, see [1, p. 233]) is sent via a time-controlled communication system to the node computer 120, where the message 115 together with the data contained therein, which represent input data for an application task 207 (computation task of the application software), arrives at a point in time 213 known a priori. This computation task 207 (of the application software) in the node computer 120 computes new setpoint values by means of a corresponding algorithm, and sends these new setpoint values in a message 125 to a node computer (actuator controller) 130 via a time-controlled communication system. The node computer 130 transfers the setpoint values to an actuator 135.

Returning once more to an event-controlled computer system, FIG. 2a shows the time sequence of the tasks for an event-controlled operating system of the node computer 120. The abscissa 200 indicates the progression of time. At a point in time 201 not known a priori, the message 115 arrives at the node computer 120 and triggers a context switch in the node computer 120.

When, as a result of the arrived message 115, an operating system of a node computer has to perform a context switch between a running application task and a new application task, in particular between computation tasks of the application software, an operating system task must specify the contents of the control registers of the computer (node computer), which characterize the properties of the runtime environment of the new application task, prior to the start time of the new application task.

The properties of the runtime environment of the new application task determine at least the following properties (regardless of whether an event-controlled or a time-controlled computer system is involved):
which data areas the application task is allowed to read,
which data areas the application task is allowed to write,
which data areas of the application task are allowed to be read or written by other tasks that are active in the operating system, and
how long the application task is allowed for its computations.

After the operating system task 205 concludes at point in time 202, an application-specific initialization task 206 in the interval between points in time 202 and 203 may validate the contents of the control registers of the computer (node computer) set by the operating system task 205, and may initialize the data structures of the application task.

The control registers of the computer are validated when at least the following conditions are met:
The data of the application task are protected from unauthorized access by other tasks.
The defined read/write rights to the data in the computer system correspond to the specification of the application task.
The addresses for the input/output data correspond to the specification of the application task.
The runtime specifications of the application software to be monitored by the operating system correspond to the specification of the application task.

After this initialization task 206 is completed at point in time 203, the application task 207 accesses the data of this real-time transaction that are transported in the message 115, and computes the new setpoint values.

At a point in time 204, the application task 207 has completed its computations and transfers the computations to the node 130 via the message 125 (FIG. 1).

Returning once more to the above description of a time-controlled computer system with reference to FIG. 1, FIG. 2b illustrates the time sequence of a task change in a time-controlled operating system of the node computer 120. The abscissa 200 indicates the progression of time. In a time-controlled system, it is known a priori that the message 115 has just arrived at the node computer 120 at a start time 213, and the application task 207 may begin the computation. According to the invention, based on this a priori knowledge, an operating system task 205 of the node computer 120 may already begin the computation of the new contents of the control registers at a point in time 211, before the message 115 arrives at the node computer 120. After the operating system task 205 is completed, an initialization task 206 begins its computations at point in time 212, so that it has concluded at start time 213 of the application task 207. At this point in time 213, known a priori, the message 115 containing the input data for the application task 207 has arrived.

At a point in time 214, the application task 207 has concluded its computations, and transfers the computations to the node 130 via the message 125 (FIG. 1).

Provided that the worst case execution time (WCET) of the operating system task 205 and of the initialization task 206 are known a priori, point in time 211 results as follows:

point in time 211=point in time 213 known a priori−WCET operating system task 205−WCET initialization task 206

At the computed point in time 211, the operating system begins the context switch, and at point in time 213, known a priori, the application task 207 begins reading the input data delivered from the time-controlled communication system.

As a result of the present invention, the execution time (also referred to as response time) of a frame in each time-controlled computer node is shortened by the WCETs of the operating system task 205 and the initialization task 206. This shortening results in an improvement in the quality of the regulation.

Cited literature:

[1] Kopetz, H. Real-Time Systems, Design Principles for Distributed Embedded Applications. Springer Verlag. 2011.

1. A method for shortening the response time in a node computer (120) of a distributed time-controlled real-time computer system, the method comprising:
computing, by an operating system task (205) of the node computer (120), the contents of control registers of the node computer (120), which characterize the properties of a runtime environment of the application task (207) in the node computer (120), prior to a start time (213), known a priori, of an application task (207) of the node computer (120), and writes these contents into the control registers of the node computer (120).

2. The method according to claim 1, wherein an initialization task (206) checks the contents of the control registers of the node computer (120), which characterize the properties of the runtime environment of the application task (207), prior to the start time (213), known a priori, of the application task (207).

3. The method according to claim 2, wherein the initialization task (120) performs an initialization of the data structures of the application task (207) prior to the start time (213), known a priori, of the application task (207).

4. A node computer (120) of a distributed time-controlled real-time computer system, on which node computer (120) an operating system is executed, and on which node computer (120) application software is executed, the node computer comprising:
an operating system task (205) of the node computer (120) computes the contents of control registers of the node computer (120), which characterize the properties of a runtime environment of the application task (207) in the node computer (120), prior to a start time (213), known a priori, of an application task (207) of the node computer (120), and writes these contents into the control registers of the node computer (120).

5. The node computer according to claim 4, wherein an initialization task (206) checks the contents of the control registers of the node computer (120), which characterize the properties of the runtime environment of the application task (207), prior to the start time (213), known a priori, of the application task (207).

6. The node computer according to claim 5, wherein the initialization task (120) performs an initialization of the data structures of the application task (207) prior to the start time (213), known a priori, of the application task (207).

7. A distributed time-controlled real-time computer system comprising node computers, wherein one or more node computers are designed as node computers according to claim 4.
